(19) United States
(12) Patent Application Publication
(10) Pub. No.: US 2008/0047884 A1
(43) Pub. Date: Feb. 28, 2008

(54) FILTRATION DEVICE HAVING VIEWING WINDOW

(76) Inventor: Hsiung-Che LEE, Kaohsiung City (TW)

Correspondence Address: LEONG C LEI, PMB # 1008, 1867 YGNACIO VALLEY ROAD, WALNUT CREEK, CA, 94598, US

(21) Appl. No.: 11/428,575

(22) Filed: Jul. 5, 2006

(51) Int. Cl. B01D 35/14

(52) U.S. Cl. 210/94; 210/95; 210/446

(57) ABSTRACT

A filtration device is provided whose body member has a transparent or translucent part (i.e., window) so that a user can directly see the colors of the filtering agents inside. If the colors of the filtering agents are changed due to the loss or degradation of functionality, the filtering agents can be replaced so that the performance of the filtration device is consistently maintained.

### BACKGROUND OF THE INVENTION

(a) Technical Field of the Invention

The present invention generally relates to filtration devices, and more particularly to a filtration device whose body has a transparent area for viewing the content inside.

(b) Description of the Prior Art

Various water filtration or purification devices are widely popular recently as people become more concerned about the quality of the water they drink and use. However, most of the water filtration device or purification devices are single-purposed. For example, a reverse osmosis water purifier is usually installed at the kitchen faucet for filtering tap water; it cannot be used to filter the cultivation water of an aquarium device. As such, there are various types of filtration or purification devices and a user has to purchase and install different types of filtration purification devices, each for a specific demand of the user. This is obviously a costly approach.

Therefore, a multi-purposed filtration device has beers proposed which contains a number of filtering agents inside, a water inlet that can be connected to the bath or kitchen faucet or the tap of a reverse osmosis (RO) water purifier or an aquarium device, and a water outlet to release the purified and filtered water. For both the single- or multi-purposed filtration devices, there are a number of disadvantages.

First of all, the body of most of the filtration devices has a fixed and rigid shape to avoid explosion from the high water pressure. The colors of the filtering agents inside would change after a period of usage as their filtering function is lost or degraded. However, the body of the filtration devices is usually opaque so that a user cannot visually and immediately examine the quality of the filtering agents to make sure the filtration device always function properly.

Secondly, even though the filtration is self-assembly, a user still has to disassembly the filtration device before the user can examine the filtering agents. This is a demanding task especially when the filtration device is complicatedly structured.

### SUMMARY OF THE INVENTION

The primary purpose of the present invention is to provide a titration device to obviate the foregoing shortcomings of prior arts. The filtration device allows a user to view the filtering agents inside to make sore if the filtering function of the filtering agents is lost or degraded and if they require replacement.

The most significant characteristic of the present invention is that the body member of the filtration device has a transparent or translucent area (i.e., window) so that a user can directly see the colors of the filtering agents inside. If the colors of the filtering agents are changed, the filtering agents can be replaced so that the performance of the filtration device is consistently maintained.

The foregoing object and summary provide only a brief introduction to the present invention. To fully appreciate these and other objects of the present invention as well as the invention itself all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective exploded diagram showing the various components of a filtration device according to a first embodiment of the present invention.

FIG. 2 is a perspective diagram showing the filtration, device of FIG. 1 after its assembly.

FIG. 3 is a perspective diagram showing the filtration device according to a second embodiment, of the present invention.

FIG. 4 is a perspective diagram showing the filtration device according to a third embodiment of the present invention.

FIG. 5 is a perspective diagram showing the filtration device according to a fourth embodiment of the present invention.

FIG. 6 is a perspective diagram showing the filtration device according to a fifth embodiment of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

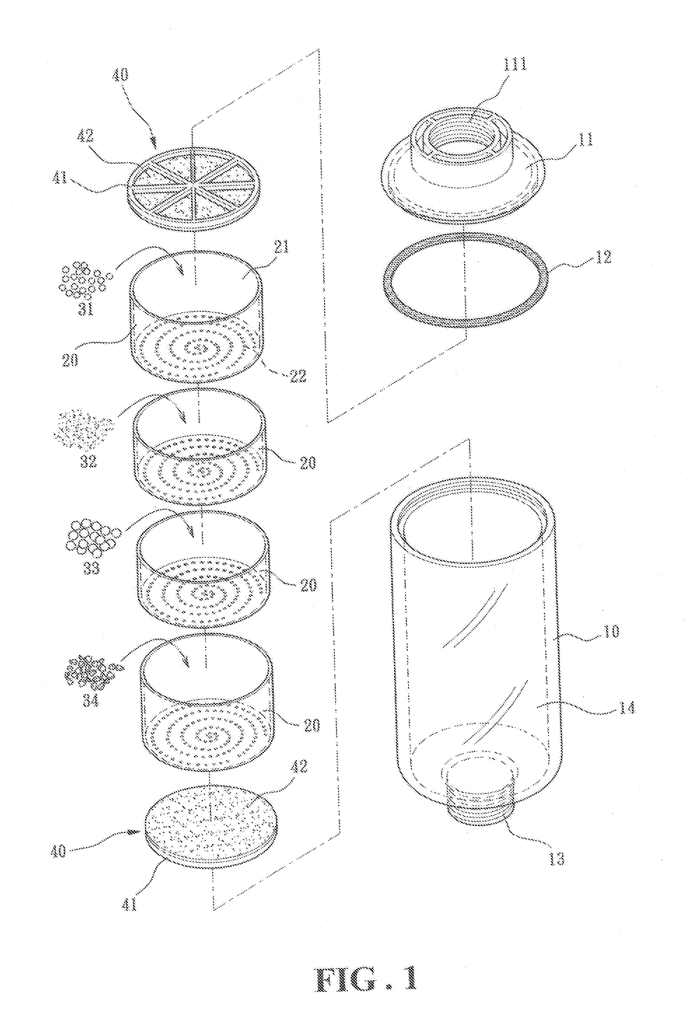

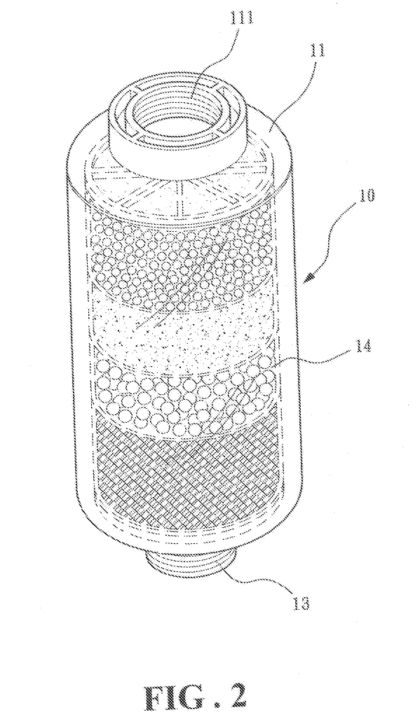

As illustrated in FIGS. 1 and 2, a first embodiment of the present invention contains a hollow body member 10 having a water inlet 111 at a top end and a water outlet 13 at a bottom end; a number of open-top container members 20 vertically stacked inside the body member 10; and a number of agent members 31, 32, 33, and 34 placed inside the container members 20 respectively. The water inlet 111 can be connected to the bath or kitchen faucet or the tap of a reverse osmosis (RO) water purifier so as to introduce water into the present invention for filtration.

The body member 10 has a cover 11 at the top end which is twisted to the body member 10 or joined to the body member 10 by a similar mechanism. A ring washer 12 is provided between the cover 11 and the body member 10 to prevent water leakage. The cover 11 as such can be easily opened for a user to access the interior space of the body member 10 for maintenance. The water inlet 111 is provided in the center of the cover 11 and has a tubular shape with threads configured on the inner wall. On the other hand, at the bottom end of the body member 10, the water outlet 13 also has a tubular shape but with threads configured on the outer wall.

The container members 20 are identically shaped with a diameter slightly smaller than that of the body member 10 so that an appropriate number of the container members 20 can be vertically stacked and reliably positioned inside the body member 10 (in the present embodiment, four container members 20 are shown). Each container member 20 provides a storage space 21 inside and a number of through holes 22 spirally arranged from the center at the bottom of the container member 20. As such, the water is forced to flow through the container member 20 in a swirl.

The agent members 31, 32, 33, and 34 can be made by one the following materials including far-infrared fine ceramic particles, high-purity copper-zinc alloy (KDF), calcium sulfite, active carbon, or similar material with water filtration function. Appropriate amounts of the agent members 31, 32, 33, and 34 are placed inside foe storage spaces 21 of the container members 20 respectively.

The present embodiment also contains two filtering members 40 positioned on top of the topmost container member 20 and beneath the bottommost container member 20 respectively. The present embodiment is designed such that when the body member 10 is sealed by its cover 11, the top filtering member 40, the stacked container members 20, and the bottom filtering member 40 are tightly joined together. As such, the filtering member 40 on the top securely covers the open top of the topmost container member 20 so that the agent member 31 inside wouldn't escape from the storage space 21. Similarly, the rest of the container members 20 are also securely and tightly stacked so that their respective agent members 32, 33, and 34 wouldn't escape and mix with other agent members. The filtering members 40 also provide additional, filtration effect. Each of the filtering members 40 contains a planar frame 41 enclosing a layer of filtering cotton 42.

After assembly water is introduced to she present embodiment by connecting the water inlet 111 to the kitchen or bath faucet (the connection is common and therefore is not shown in the drawings), filtered through, the agent, members 31, 32, 33, 34 of the container members 20 sequentially and then the filtered water is supplied through the water outlet 13.

For the first embodiment shown in FIGS. 1 and 2, the body member 10 is made of a transparent material so that a transparent part 14 is integrally formed when the body member 10 is manufactured. Through the transparent part 14, a user can directly see if the agent members 31, 32, 33, and 34 have changed their colors and decide whether the filtering function of the agent members 31, 32, 33, and 34 is lost or degraded. By removing the cover 11, the interior of the body member 10 can be accessed and the agent members 31, 32, 33, and 34 can be replaced to maintain the performance of the filtration device.

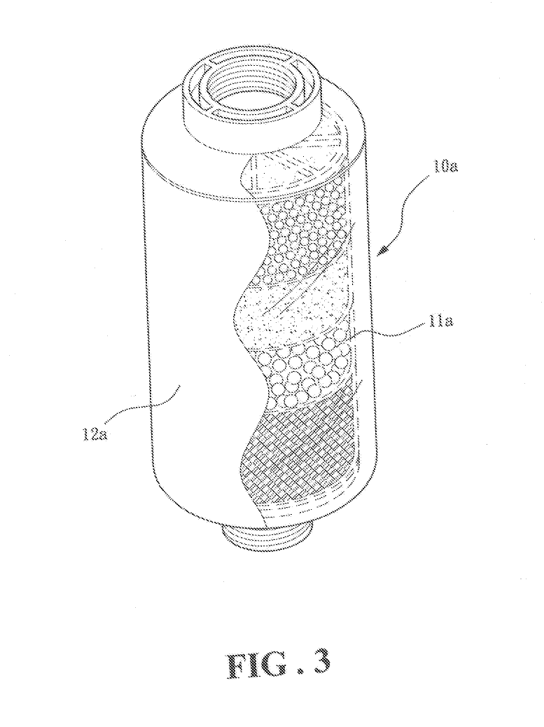

As shown in FIG. 3, the body member 10a of a second embodiment of tire present invention contains a transparent part 11a and another opaque part 12a. The opaque part 12a can the integrally formed during the manufacturing of the body member 10a by an opaque material. Another approach is to have a transparent body member 10a but cover part of the body member 10a by a colored and opaque paint to form foe opaque part 12a. Again, through the transparent part 11a, a user can directly see if the agent members have changed their colors and decide whether the filtering function of the agent members is lost or degraded.

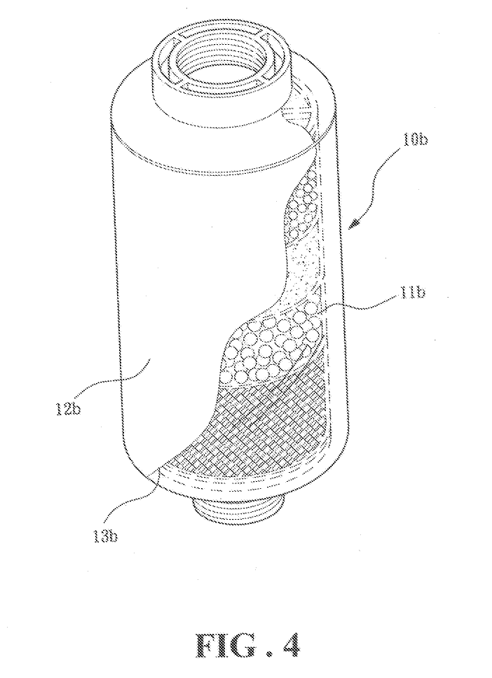

As shown in FIG. 4, the body member 10b of a third embodiment of the present invention also contains a transparent part 11b and another opaque part 12b. A curved interface 13b is provided along foe border between the transparent part 11b and the opaque part 12b.

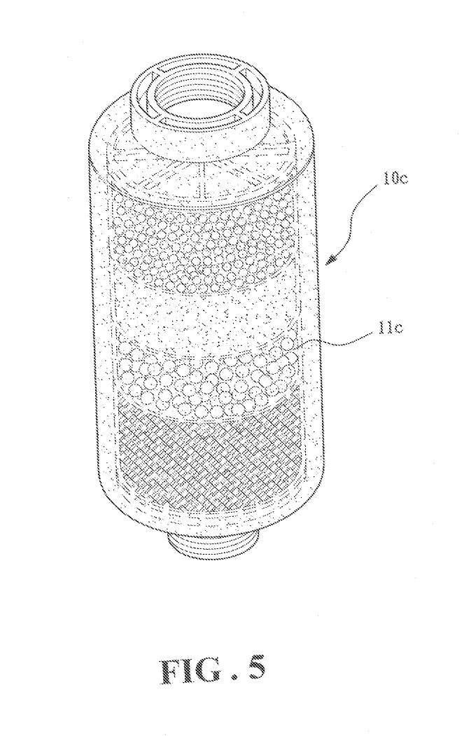

As shown in FIG. 5, the body member 10c of a fourth embodiment of the present invention is made of the translucent material and a translucent part 11c is integrally formed. The translucent part 11c has a degree of haze or has a jelly-like color. Again, through the translucent part 11c, a user can directly see if the agent members have changed their colors and decide whether the filtering function of the agent members is lost or degraded.

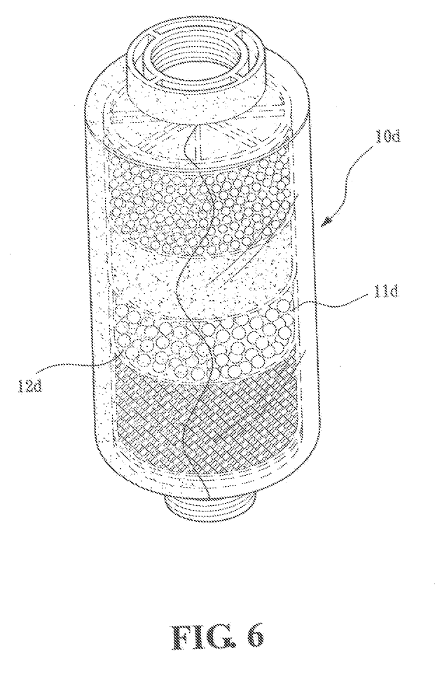

As shown in FIG. 6, the body member 10d of a fifth embodiment of the present invention contains a transparent part 11d and another translucent part 12d having a degree of haze or a jelly-like color. Through the translucent part 12d, a user can directly see if the agent members have changed their colors and decide whether the filtering function of the agent members is lost, or degraded.

It will be understood that each of the elements described above, or two or more together may also find a useful application in other types of methods differing fern the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made try those skilled in the art without departing in any way from the spirit of the present invention.

I claim:

1. A filtration device, comprising:
a hollow body member having a water inlet and a water outlet at two ends; and
a filtering structure housed inside said body member containing at least a filtering agent;
wherein said body member contains a transparent part allowing said filtering agent to be visible from outside of said body member.

2. The filtration device according to claim 1, wherein said body member former contains an opaque part.

3. The filtration device according to claim 2, wherein said opaque part is integrally formed by an opaque material.

4. The filtration device according to claim 2, wherein said opaque part is a colored paint.

5. The filtration device according to claim 2, wherein a curved interface is at the border between said transparent part and said opaque part.

6. A filtration device, comprising:
a hollow body member having a water inlet and a water outlet at two ends; and
a filtering structure housed inside said body member containing at least a filtering agent;
wherein said body member contains a translucent part allowing said filtering agent to be visible from outside of said body member.

7. The filtration device according to claim 6, wherein said body member former contains a transparent part.

8. The filtration device according to claim 7, wherein said translucent part is integrally formed by a translucent material.

9. The filtration, device according to claim 7, wherein said translucent part has a degree of haze or a jelly-like color.

10. The filtration device according to claim 7, wherein a curved interface is at the border between said transparent part and said translucent part.
